(19) United States
(12) Patent Application Publication
(10) Pub. No.: US 2014/0324983 A1
(43) Pub. Date: Oct. 30, 2014

(54) INSTANT MESSAGE ROUTING AND MULTI-MACHINE LOG-ON MANAGEMENT

(71) Applicant: INTERNATIONAL BUSINESS MACHINES CORPORATION, Armonk, NY (US)

(72) Inventors: Zachary A. Burns, Poughkeepsie, NY (US); Yuk L. Chan, Poughkeepsie, NY (US); Kin K. Choi, Poughkeepsie, NY (US); David J. Flaherty, Poughkeepsie, NY (US); Mark A. Scott, Rhinebeck, NY (US)

(73) Assignee: International Business Machines Corporation, Armonk, NY (US)

(21) Appl. No.: 13/873,327

(22) Filed: Apr. 30, 2013

(51) Int. Cl. H04L 12/58

(52) U.S. Cl. CPC H04L 51/04
USPC 709/206

(57) ABSTRACT

Embodiments relate to customizing instant messaging traffic. An aspect includes receiving a first association between a contact and a category and a second association between the category and one or more receiving client devices. A status from the one or more receiving client devices is routed to the contact based on the first and second associations. Additionally, a message from the contact is routed to the one or more receiving client devices based on the first and second associations.

### BACKGROUND

The present invention relates generally to instant messaging, and more specifically, to customizing the routing of instant messages from a sender to one or more receiving client devices based on category associations.

Instant messaging or online chatting has become an integral means of communication in contemporary society. Instant messaging plays an essential role in many aspects of people's lives such as communication with co-workers, communications with friends, online dating, and is integrated into a chat facility on many popular social media applications. Typically, the same instant messaging application must be used for both personal and business communications. Accordingly, users typically utilize different login credentials to facilitate communication for different purposes, such as personal or business communications. A user, therefore, has to manage multiple login credentials because many contemporary instant messaging applications do not allow the user to run multiple copies of the same application. Moreover, the user may have to manage multiple contact lists due to situations where a business contact might also be a personal contact.

### BRIEF SUMMARY

According to an embodiment of the present invention, a method for customizing instant messaging traffic is provided. The method includes receiving a first association between a contact and a category and a second association between the category and one or more receiving client devices. A status from the one or more receiving client devices is routed to the contact based on the first and second associations. Additionally, a message from the contact is routed to the one or more receiving client devices based on the first and second associations.

According to another embodiment of the present invention, a system for customizing instant messaging traffic is provided. The system includes a computer processor and logic executable by the computer processor. The logic is configured to implement a method. The method includes receiving a first association between a contact and a category and a second association between the category and one or more receiving client devices. A status from the one or more receiving client devices is routed to the contact based on the first and second associations. Additionally, a message from the contact is routed to the one or more receiving client devices based on the first and second associations.

According to a further embodiment of the present invention, a computer program product for customizing instant messaging traffic is provided. The computer program product includes a storage medium having computer-readable program code embodied thereon, which when executed by a computer processor, causes the computer processor to implement a method. The method includes receiving a first association between a contact and a category and a second association between the category and one or more receiving client devices. A status from the one or more receiving client devices is routed to the contact based on the first and second associations. Additionally, a message from the contact is routed to the one or more receiving client devices based on the first and second associations.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification.

The forgoing and other features, and advantages of the invention are apparent from the following detailed description taken in conjunction with the accompanying drawings in which:

FIG. 1 depicts a block diagram of a computer system according to an embodiment;

FIG. 2 depicts a flow diagram of a process for customizing the routing of instant messages from a sender to one or more receiving client devices based on category associations according to an embodiment;

FIG. 3 depicts a diagrammatic example of associating a contact to a category according to an embodiment;

FIG. 4 depicts a diagrammatic example of installing and configuring a client according to an embodiment;

FIG. 5 depicts a diagrammatic example of routing a user's status to a contact based on a category and receiving a message on a receiving client device according to an embodiment;

FIG. 6 depicts a diagrammatic example of routing a user's status to a contact based on a client device and receiving a message on a receiving client device according to an embodiment; and

FIG. 7 depicts a diagrammatic example of routing behaviors for messages sent to one or more receiving client devices based on a status of the receiving client device according to an embodiment.

### DETAILED DESCRIPTION

Embodiments disclosed herein are directed to customizing the routing of instant messages from a sender to one or more receiving client devices based on category associations. Embodiments include receiving a first association between a contact and a category. A second association is then received between the category and one or more receiving client devices. Accordingly, a status from the one or more receiving client devices is routed to the contact based on the first and second associations and a message from the contact is routed to the one or more receiving client devices based on the first and second associations.

In some contemporary instant messaging tools, a user may log-on to a single instant messaging tool and assign contacts to different categories. While this feature may provide categorization of chat partners and chat purposes, and may simplify log-on credential management, it does not possess the flexibility that multiple login credentials may provide. Accordingly, embodiments disclosed herein provide a single log-on credential that handles chats of different purposes while allowing a user to receive chat messages from a sender to one or more receiving client devices based on category associations.

For example, a user may set a preference to only receive messages from work contacts on his work laptop and receive messages from personal contacts on his smart phone according to embodiments. Additionally, a user may set a preference to only receive messages from work contacts at his work laptop during the day and receive messages from work contacts at his home computer during the evening. Embodiments further provide different statuses (e.g., away, busy, available) based on the current receiving client's machine condition (e.g., screen saver is on) and the category of the contact. According to additional embodiments, a user may set a preference to receive a notification on a home computer when a work laptop receives a message about work, while the user is actively chatting with a personal contact on the user's home computer. A user may also set a preference to allow the transfer of messages from the work laptop to the home computer. According to embodiments, if there are multiple messaging systems in use, these different systems may be virtualized into a single tool, such that the user only knows about the categories of contacts and manages the categories.

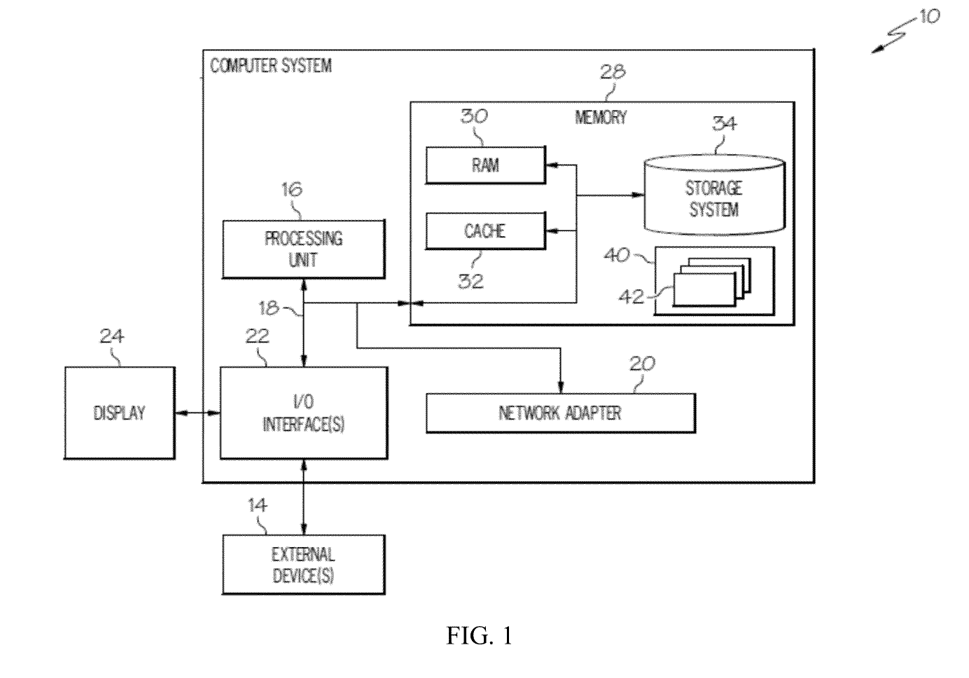

Referring now to FIG. 1, a block diagram of a computer system 10 suitable for customizing the routing of instant messages from a sender to one or more receiving client devices based on category associations according to exemplary embodiments is shown. Computer system 10 is only one example of a computer system and is not intended to suggest any limitation as to the scope of use or functionality of embodiments described herein. Regardless, computer system 10 is capable of being implemented and/or performing any of the functionality set forth hereinabove.

Computer system 10 is operational with numerous other general purpose or special purpose computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a general-purpose computing device, also referred to as a processing device. The components of computer system may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, and data archival storage systems, etc.

Embodiments disclosed herein provide a method, system, and computer program product to categorize groups within a contact or chat partner list and assign to those groups specific attributes. Based on the attributes of the group the instant messaging service provider server of an embodiment selects a receiving client device to send a message to. According to an embodiment, the attributes of each category may include, but are not limited to, time intervals for each device (e.g., for automatic away status when client device is idle), away message options, and message queuing settings (e.g., for buffering incoming messages when offline).

Categorizing contacts or chat partners into groups allows a user to customize instant massaging traffic to a particular client device for each group in a contact list according to embodiments. According to embodiments, a user may use a single credential and instant messaging tool for multiple purposes (e.g., work, friends, or strangers) and still have the option of specifying which client device should receive new messages depending on a contact's categorization. Moreover, based upon a user's specified categories, embodiments allow a user to display more relevant and meaningful status messages to his contacts.

According to an embodiment, a user may configure a client device to different categories and associate each contact to the one or more categories as discussed further below. Each category may have a status, which is generated or customized by the user based on one or more of the client device's statuses according to embodiments. Accordingly, each contact will see the user's status, which may be generated or customized by the user based on the one or more categories. The user status may be a consolidated status or a listing of the status of client devices. According to embodiments, the user may selectively receive messages on different client devices based on the assigned categories of a contact and the status of the client device. Embodiments disclosed herein may be implemented on any applications that provide user status. The status of embodiments may also control other mechanisms. For example, the status of an embodiment may determine which chat categories and client devices permit video and audio chat.

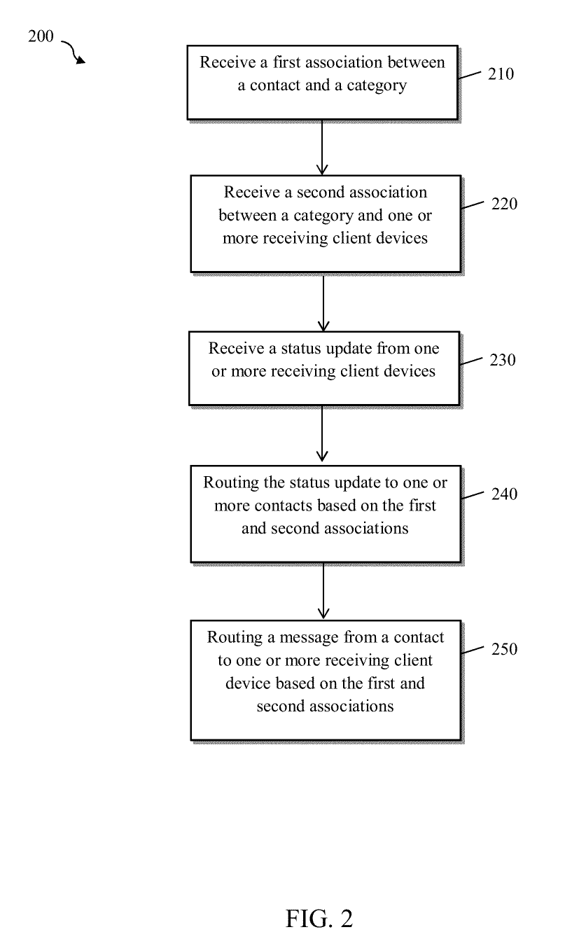

With reference to FIG. 2, a process 200 performed by an embodiment of processing device 16 of computer system 10 is generally shown. As shown in FIG. 2, the process 200 customizes the routing of instant messages from a sender to one or more receiving client devices based on category associations according to an embodiment.

At block 210, a category manager of an embodiment may receive a first association between a sender and a category. The category manager of an embodiment manages the categories assigned to each contact and each receiving client device. The category manager may reside on a category manager database server and/or may reside on a sending/receiving client according to an embodiment.

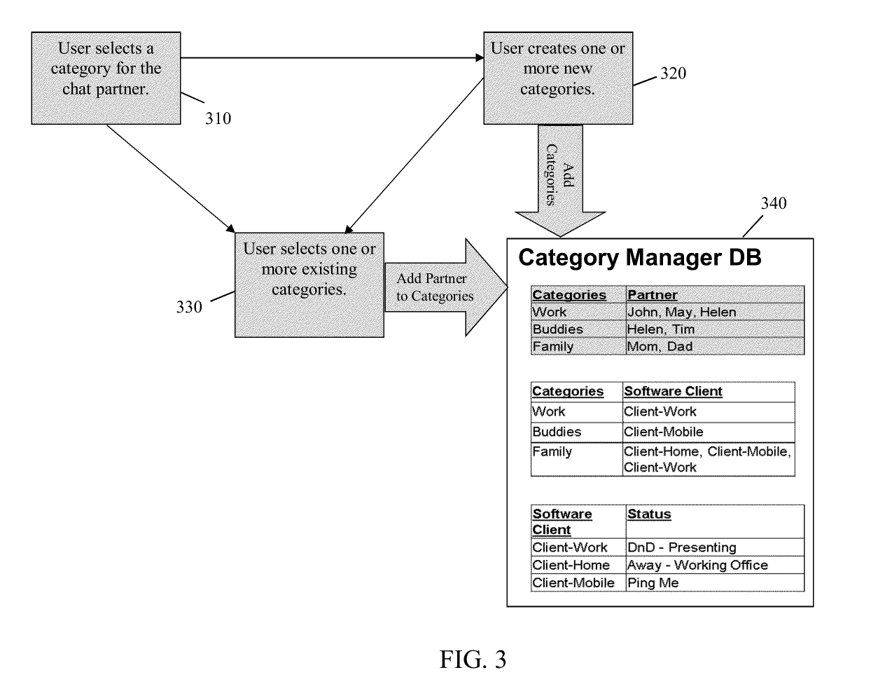

FIG. 3 depicts a diagrammatic example of associating a contact to a category according to an embodiment. As shown in FIG. 3, a user may select a category for each chat partner (block 310). The category assigned to each contact may be newly created (block 320) or may be selected from one or more existing categories (block 330). The association between the contacts and one or more categories is stored in the category database 340 by the category manager.

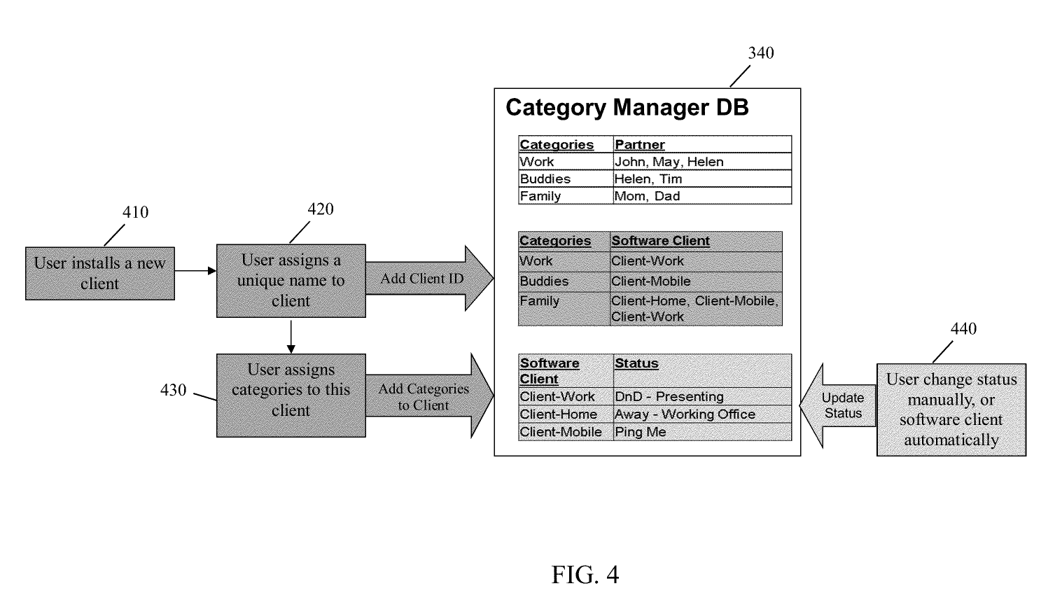

Referring to block 220 of FIG. 2, the category manager may receive a second association between the category and one or more receiving client devices. FIG. 4 depicts a diagrammatic example of installing and configuring a client according to an embodiment. As shown in FIG. 4, the user may install a new client (block 410) assign the new client with a unique client identification or name during installation (block 420). According to an embodiment, the user may assign one or more categories to the new client (block 430). The association between the one or more receiving client devices and the one or more categories may be stored in the category manager database 340 by the category manager.

Referring to block 230 of FIG. 2, a status update may be received from the one or more receiving devices. As further shown in FIG. 4, a user may change the status manually or the client device may automatically change the status (e.g., device goes idle due to inactivity).

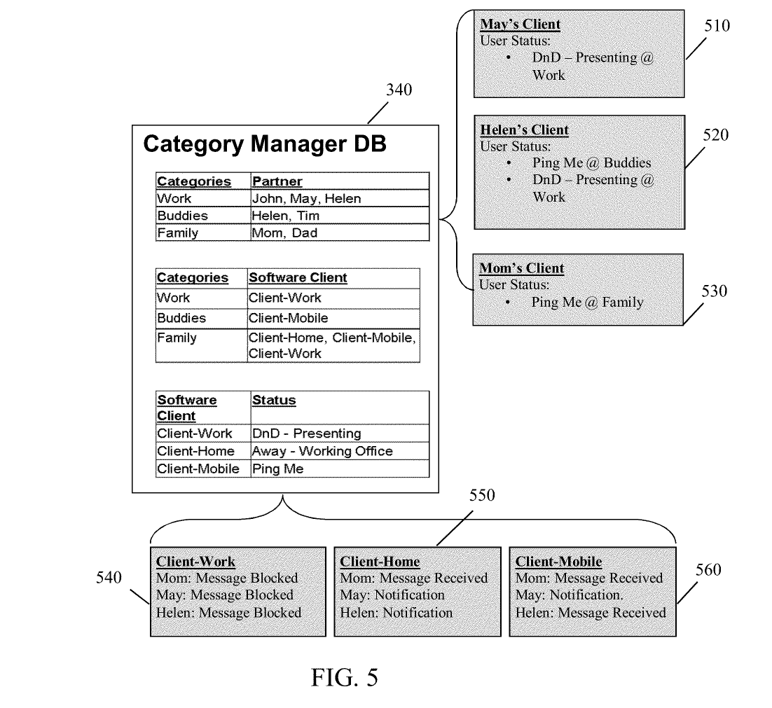

Referring to block 240 of FIG. 2, a user status may be routed from the one or more receiving client devices to a contact based on the first and second associations. According to an embodiment, a plurality of user statuses may be routed to a contact based on the first and second associations. FIG. 5 depicts a diagrammatic example of routing a user's status to a contact based on a category and receiving a message on a receiving client device according to an embodiment. As shown in FIG. 5, a client of each contact (e.g., May 510, Helen 520, and Mom 530) may receive one or more user statuses based on a category. The user statuses may include, but are not limited to away, busy, and do not disturb, available, ping me, and the like.

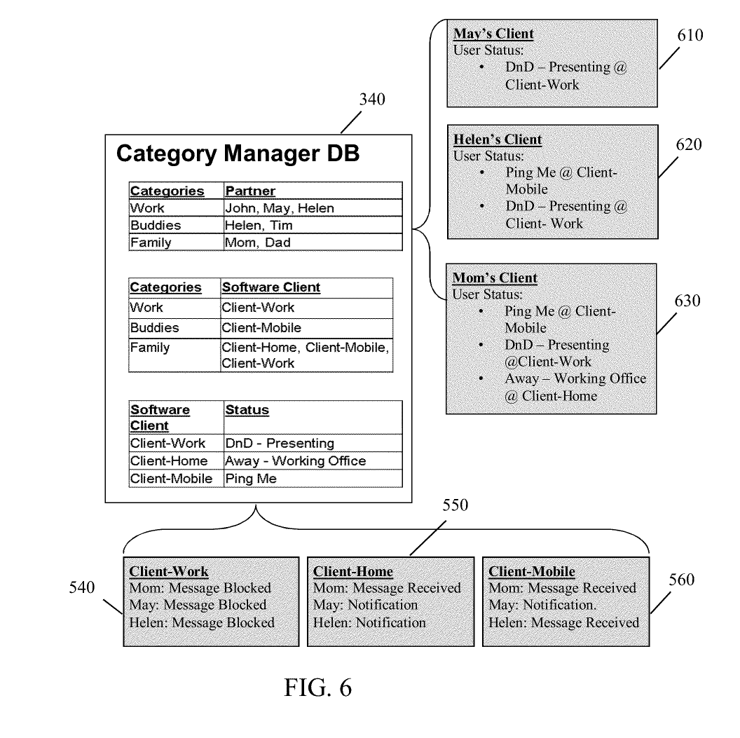

According to another embodiment, a client of each contact (e.g., May 610, Helen 620, and Mom 630) may receive one or more user statuses based on one or more receiving client device (e.g., Client-Work 540, Client-Home 550, Client-Mobile 560), as shown in FIG. 6. Accordingly, embodiments provide that a client of each contact may receive one or more user statuses based on either a designated category or based on the one or more receiving client devices.

Referring to block 250 of FIG. 2, a message from one of the contacts may be received at the one or more receiving client devices (e.g., Client-Work 540, Client-Home 550, Client-Mobile 560) based on the first and second associations. According to an embodiment, the routing behavior of a message from the one or more contacts may be customized for the one or more client devices 540, 550, 560 based on the first and second associations. For example, as shown in FIG. 5, the routing behavior may be customized to block a message, receiving a notification, or receive a message from one or more contacts based on the category associations of the contacts and the receiving client devices.

According to an embodiment, a message sender has the option to specify a category for which the message is intended. According to another embodiment, the category manager may run a known analytic algorithm on the message to automatically determine a category designation for the message, based on the sender profile or the contents of the message, for example, and direct the message to the designated category.

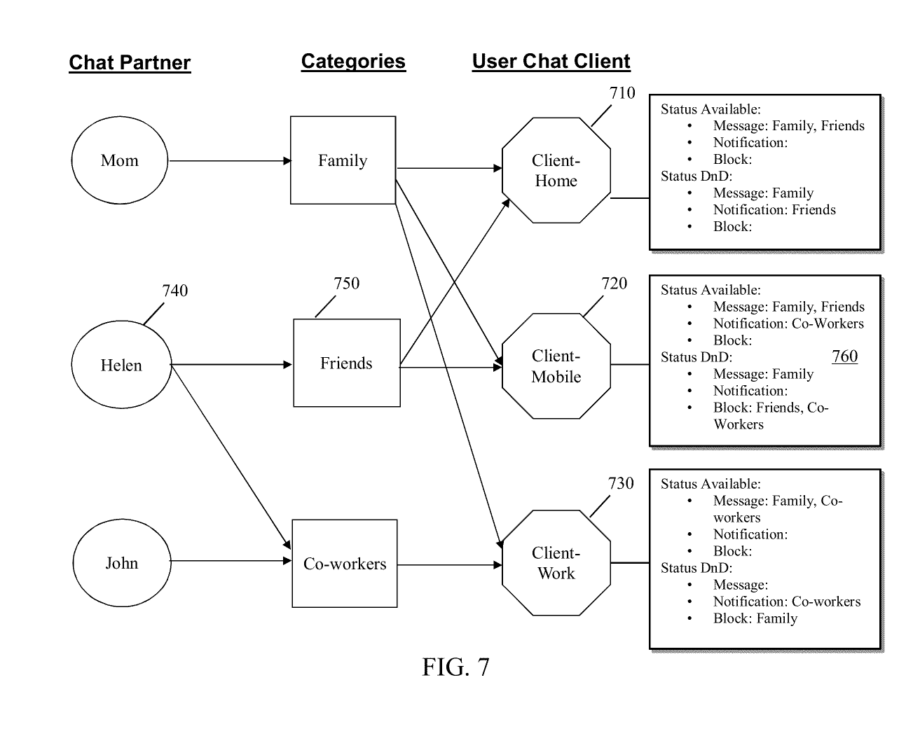

With reference to FIG. 7, a diagrammatic example of routing behaviors for messages sent to one or more receiving client devices based on a status of the receiving client device according to an embodiment is generally shown. As shown in FIG. 7, a routing behavior may be configured for each receiving client device (e.g., Client-Home 710, Client-Mobile 720, and Client-Work 730) based on a status. For instance, a contact, Helen 740, is associated with the same category, Friends 750, as Client-Mobile 720. Accordingly, a message sent from Helen 740 to the Client-Mobile 720 is routed according to a status 760 of Client-Mobile 720. In this particular example, if the status 760 of Client-Mobile 720 is available, then the message from Helen 740 is sent to the Client-Mobile 720. If the status 760 of Client-Mobile 720 is do not disturb (DnD), then the message from Helen 740 is blocked for the Client-Mobile 720.

Technical effects and benefits include providing a single log-on credential that handles chats of different purposes while allowing a user to receive chat messages from a sender to one or more receiving client devices based on category associations. Particularly, embodiments match a category associated with a contact or a sender to a category associated with a receiving client device. Based on this association, an instant message is selectively routed to one or more receiving client devices.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for customizing instant messaging traffic, comprising:
receiving, by a processing device, a first association between a contact and a category;
receiving a second association between the category and one or more receiving client devices;
routing a status from the one or more receiving client devices to the contact based on the first and second associations, and
routing a message from the contact to the one or more receiving client devices based on the first and second associations.

2. The computer-implemented method of claim 1, wherein each category is assigned attributes, the attributes comprising a selected one of status routing preferences, message routing preferences, time intervals for each receiving client device, away message options, and message queuing settings.

3. The computer-implemented method of claim 1, further comprising:
receiving a status update from the one or more receiving devices, wherein the status update is manually changed by a user or automatically changed based on an attribute assigned to each category or each client device.

4. The computer-implemented method of claim 1, wherein the routing of the status further comprises routing a plurality of user status to one or more contacts based on the first and second associations.

5. The computer-implemented method of claim 1, wherein the routing of the message further comprises:
customizing a behavior for the one or more client devices based on the first and second associations, the behavior comprising a selected one of blocking the message, receiving a notification, and receiving the message.

6. The computer-implemented method of claim 1, wherein the routing of the message further comprises providing a message sender an option to specify a category for which the message is intended.

7. The computer-implemented method of claim 1, wherein the routing of the message further comprises automatically determining a category designation for a message and directing the message to the designated category.

8. A computer system for customizing instant messaging traffic, comprising:
a memory having computer readable computer instructions and a processor for executing the computer readable instructions to perform a method comprising:
receiving a first association between a contact and a category;
receiving a second association between the category and one or more receiving client devices;
routing a status from the one or more receiving client devices to the contact based on the first and second associations, and
routing a message from the contact to the one or more receiving client devices based on the first and second associations.

9. The computer system of claim 8, wherein each category is assigned attributes, the attributes comprising a selected one of status routing preferences, message routing preferences, time intervals for each receiving client device, away message options, and message queuing settings.

10. The computer system of claim 8, further comprising:
receiving a status update from the one or more receiving devices, wherein the status update is manually changed by a user or automatically changed based on an attribute assigned to each category or each client device.

11. The computer system of claim 8, wherein the routing of the status further comprises routing a plurality of user status to one or more contacts based on the first and second associations.

12. The computer system of claim 8, wherein the routing of the message further comprises:
customizing a behavior for the one or more client devices based on the first and second associations, the behavior comprising a selected one of blocking the message, receiving a notification, and receiving the message.

13. The computer system of claim 8, wherein the routing of the message further comprises providing a message sender an option to specify a category for which the message is intended.

14. The computer system of claim 8, wherein the routing of the message further comprises automatically determining a category designation for a message and directing the message to the designated category.

15. A computer program product for customizing instant messaging traffic, the computer program product comprising:
a computer readable storage medium having program code embodied therewith, the program code executable by a processing device for:
receiving a first association between a contact and a category;
receiving a second association between the category and one or more receiving client devices;
routing a status from the one or more receiving client devices to the contact based on the first and second associations, and
routing a message from the contact to the one or more receiving client devices based on the first and second associations.

16. The computer program product of claim 15, wherein each category is assigned attributes, the attributes comprising a selected one of status routing preferences, message routing preferences, time intervals for each receiving client device, away message options, and message queuing settings.

17. The computer program product of claim 15, wherein the routing of the status further comprises routing a plurality of user status to one or more contacts based on the first and second associations.

18. The computer program product of claim 15, wherein the routing of the message further comprises:
customizing a behavior for the one or more client devices based on the first and second associations, the behavior comprising a selected one of blocking the message, receiving a notification, and receiving the message.

19. The computer program product of claim 15, wherein the routing of the message further comprises providing a message sender an option to specify a category for which the message is intended.

20. The computer program product of claim 15, wherein the routing of the message further comprises automatically determining a category designation for a message and directing the message to the designated category.
